(19) United States
(12) Patent Application Publication
(10) Pub. No.: US 2023/0229016 A1
(43) Pub. Date: Jul. 20, 2023

(54) EYEWEAR, METHOD OF MANUFACTURE AND USE THEREOF

(71) Applicant: Syed AFTAB, Singapore (SG)

(72) Inventor: Syed AFTAB, Singapore (SG)

(21) Appl. No.: 18/001,692

(22) PCT Filed: Jun. 22, 2021
(86) PCT No.: PCT/SG2021/050360

§ 371 Date: Dec. 13, 2022

(30) Foreign Application Priority Data
Jun. 23, 2020 (SG) 10202006014X

(51) Int. Cl. G02C 3/00; G02C 5/14

(52) U.S. Cl. CPC G02C 3/003; G02C 5/143

(57) ABSTRACT

Disclosed herein is an eyewear, optionally without nose supports/pads. The eyewear comprises a frame to receive a pair of lens; a pair of side supports adapted to pivot about a zygomatic region of a wearer’s face; and a pair of temple cables arranged to contact ear portions the wearer; wherein each of the temple cable is adjustable so as to provide a counter-weight to the frame.

### TECHNICAL FIELD

The present disclosure relates to an eyewear, in particular eyewear suitable for use without nose support/pads.

### BACKGROUND

The following discussion of the background is intended to facilitate an understanding of the present disclosure only. It should be appreciated that the discussion is not an acknowledgement or admission that any of the material referred to was published, known or is part of the common general knowledge of the person skilled in the art in any jurisdiction as of the priority date of the invention.

Conventional eyeglasses typically include a frame, a pair of temple bars and a nose support, which can be in the form of a pair of nose pads arranged to engage/pinch a bridge of a wearer’s nose. The eyeglasses will be supported on a wearer’s face in part due to the combination of temple bars and nose pads.

However, in some situations the use of nose supports may not be desirable, for example, when the nose bridge is injured. Nose supports may also compromise the aesthetic quality of a wearer’s face. Although some documents may teach the possibility of eyewear without nose support, these documents do not adequately re-distribute weight of the eyewear to avoid the eyewear resting on a wearer’s nose.

There exists a need for an eyewear to alleviate the aforementioned problem.

### SUMMARY

Other aspects and features of the present disclosure will become apparent to those of ordinary skill in the art upon review of the following description of specific embodiments of the invention in conjunction with the accompanying figures.

The disclosure seeks to re-distribute the weight of the eyeglass from the nose to the side of the face as posteriorly as possible. The weight is preferably redistributed, via side supports, on a zygomatic region of a person’s face, and more preferably the weight is redistributed on the “zygomatic arch” of a person’s face. In addition, temple cables preferably may be provided so that it can be attached (for example hooked) on to the back of a wearer’s ear. Such temple cables preferably provide a “counterweight” or “support” so the frame of the eyewear does not fall onto the nose when worn. In some embodiments, the support may be shaped and dimensioned so as to contact any part of the wearer’s head.

In an aspect of the disclosure there is an eyewear comprising a frame to receive a pair of lens; a pair of side supports adapted to pivot about a zygomatic region of a wearer’s face; and a pair of temple cables arranged to contact one or more ear portions of the wearer; wherein each of the temple cable is adjustable so as to provide a counter-weight to the frame.

In some embodiments, the eyewear comprises a pair of temple bars extending from the frame, and wherein the pair of temple cables is arranged as an extension from the pair of temple bars. In embodiments where temple bars are present, adjustment to the temple cables may be via movement of the temple cables along a person’s temple bar as desired by a wearer.

In some embodiments, the eyewear comprises a weight attached to an end portion of each of the temple cables.

In some embodiments, each of the pair of side supports is shaped and dimensioned to contact a zygomatic arch of the wearer.

In some embodiments, each side support comprises a pad formed from at least one of: silicone, plastic, rubber, and a combination of the aforementioned.

In some embodiments, each side support is formed from a resilient material. The side support may suitably be arranged such as to be biased towards each other.

In some embodiments, each temple bar comprises a hook portion configured to engage a portion of the wearer’s ear.

In another aspect of the disclosure there is a method of producing an eyewear without nose supports/pads comprising the steps of: (a.) providing a frame, the frame shaped and dimensioned to receive a pair of lens; (b.) providing a pair of side supports, the pair of side supports adapted to pivot about a zygomatic region of a wearer’s face; and (c.) providing a pair of temple cables arranged to contact ear portions of the wearer, wherein each of the temple cable is adjustable so as to provide a counter-weight to the frame.

In some embodiments, the step of providing a pair of side supports includes a step of pivoting about a zygomatic arch of the wearer.

In some embodiments, the step (c.) includes the step of providing a weight at an end portion of each of the temple cables.

In another aspect of the disclosure there is a method of using an eyewear having frame, a pair of side supports, a pair of temple cables and a pair of temple bars. The method of use may comprise the steps of: (a.) adjusting the pair of side supports so that when worn the pair of side supports is adapted to pivot about a zygomatic region of a wearer’s face; and (b.) adjusting the pair of temple cables so as to provide a counter-weight to the frame.

In another aspect of the disclosure there is an eyewear comprising a frame to receive a pair of lens; a pair of temple bars extending from the frame; a side support positioned on each temple bar, the side support adapted to contact a zygomatic region of a wearer’s face; and a temple contact extending from each temple bar, the temple contact pivotably connected to the temple bar via a friction hinge.

In another aspect of the disclosure there is an eyewear comprising a frame to receive a pair of lens; a pair of temple bars extending from the frame; a pair of side supports adapted to contact a zygomatic region of a wearer’s face; wherein each side support is an elongate silicone pad, the elongate silicone pad having a surface coated with an elastomeric material/elastomer.

In another aspect of the disclosure there is an eyewear comprising a frame to receive a pair of lens; a pair of temple bars extending from the frame; a side support positioned on each temple bar, the side support adapted to contact a zygomatic region of a wearer’s face; and a temple contact extending from each temple bar, the temple contact pivotably connected to the temple bar via a friction hinge; wherein each side support is an elongate silicone pad, the elongate silicone pad having a surface coated with an elastomeric material/elastomer.

From a lever perspective, the eyewear may be regarded as a first class lever pivotable about a zygomatic region of the wearer.

### BRIEF DESCRIPTION OF DRAWINGS

In the figures, which illustrate, by way of example only, embodiments of the present invention,

FIG. 1 is a perspective view of an eyewear, in the form of a pair of eyeglasses or spectacles without nose supports/pads according to an embodiment;

FIG. 2 is a zoom-in view of a side support of the eyewear shown in FIG. 1;

FIG. 3 is a zoom-in view of a temple cable for the eyewear shown in FIG. 1;

FIG. 4 is a flow chart of a method for producing an eyewear;

FIG. 5 is a flow chart of a method of using an eyewear of the present disclosure;

FIGS. 6a to 6e show perspective views of another embodiment of the eyewear; and

FIG. 7 shows an embodiment of a side support and temple contact for use with the eyewear of FIGS. 6a to 6e.

### DESCRIPTION OF EMBODIMENTS

As used herein, the term ‘eyewear’ includes eyesight correction/assistive devices such as spectacles, protective eyewear such as sunglasses, aesthetic eyewear and/or combinations of the above.

As used herein, the term ‘zygomatic region’ includes the region of the face outlined by a zygomatic bone, typically above a cheek of a mammalian animal, such as a human being.

As used herein, the term ‘zygomatic arch’ is part of the zygomatic region, and refers to an arch formed by the temporal process of the zygomatic bone and the zygomatic process of the temporal bone. More specifically, the “zygomatic arch” is named the temporal process of the zygomatic bone (part of the cheekbone) at the anterior/front end, and the posterior/rear portion is named the zygomatic process of the temporal bone. In other words, the zygomatic arch refers to a bony ridge where the zygomatic and temporal bones fuse.

As used herein, the term ‘counter-weight’ broadly includes any mechanism that can provide a counter force to balance the weight of the frame portion of the eyewear so that the eyewear minimizes contact with the nose of the wearer.

As used herein, unless the context requires otherwise, the term “comprise” or variations such as “comprises” or “comprising”, will be understood to imply the inclusion of a stated integer or group of integers but not the exclusion of any other integer or group of integers.

As used herein, unless the context requires otherwise, the term “include” or variations such as “includes” or “including”, will be understood to imply the inclusion of a stated integer or group of integers but not the exclusion of any other integer or group of integers.

As used herein, unless the context requires otherwise, the term “have” or variations such as “has” or “having”, will be understood to imply the inclusion of a stated integer or group of integers but not the exclusion of any other integer or group of integers.

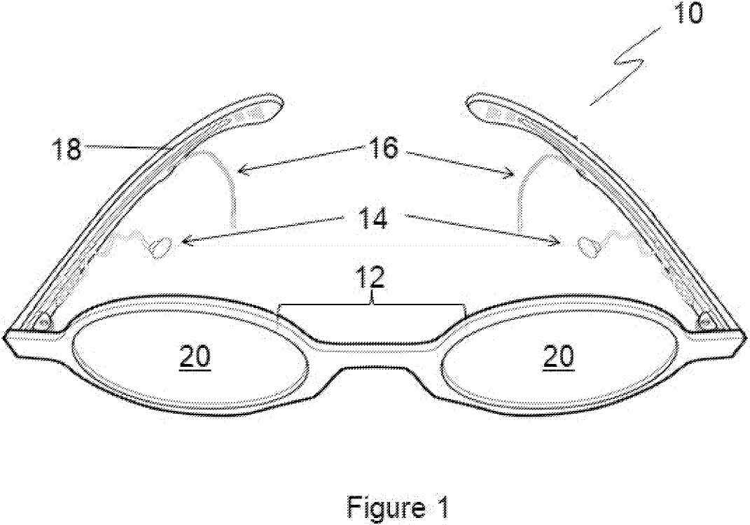

FIG. 1 shows an embodiment of the present disclosure, in the form of a pair of eyeglasses or spectacles 10. The pair of spectacles 10 comprises a frame 12, a pair of side supports 14 and a pair of temple cables 16. The pair of spectacles 10 shown may also include a pair of temple bars 18. The embodiment of FIG. 1 does not have nose supports, although it is contemplated that the spectacles 10 can include both side supports 14 and nose support(s).

The frame 12 is shaped and dimensioned to receive a pair of lenses 20. Such lens 20 may be in the form of eyesight corrective lens for the correction or mitigation of myopia, hyperopia and/or astigmatism. The pair of lenses 20 may also include protective lenses for shielding harmful radiation such as ultraviolet radiation. The protective lenses may form part of a pair of sunglasses.

The pair of temple bars 18 extends from the frame 12 in a manner such as to extend towards a human person’s ear when the pair of spectacles is worn. Suitable material of the temple bars 18 may include plastic, metal, silicone, and/or combinations of the aforementioned materials.

The temple cables 16 may be formed from a metal, such as steel, preferably stainless steel, and more preferably stainless steel of surgical grade. The temple cables 16 may be configured to extend from the temple bars 18 such that when worn, the temple cables 16 are hooked around the wearer’s ears. An end portion 22 of one or both the temple cables 16 may be weighted, that is, the end portion 22 may be shaped and dimensioned to urge the temple cables 16 towards a portion of the wearer’s ears when worn.

The pair of side supports 14 may each include a pad 24 shaped and dimensioned to contact and pivot about a zygomatic region of a wearer’s face when worn. Preferably, the pad 24 is as posteriorly situated on the zygomatic arch as possible such as when worn, the side pads 24 are inconspicuous. This in turn will make the pressure marks / dents they create on a wearer’s face also inconspicuous. Ideally, the pad 24 may be positioned such that it contacts an area of the side-burns of the wearer so that the pads are hidden from sight as much as possible.

It is contemplated that the pair of temple cables 16 are adjustable so as to provide a counter-weight/counter-force to the frame 12 while the whole eyewear 10 is pivotable about the pad 24 which contacts the zygomatic region of the wearer’s face, when worn.

In some embodiments, the eyewear 10 may be integrally molded.

In some embodiments, the frame 12 may be formed from acetate or compounds containing acetate.

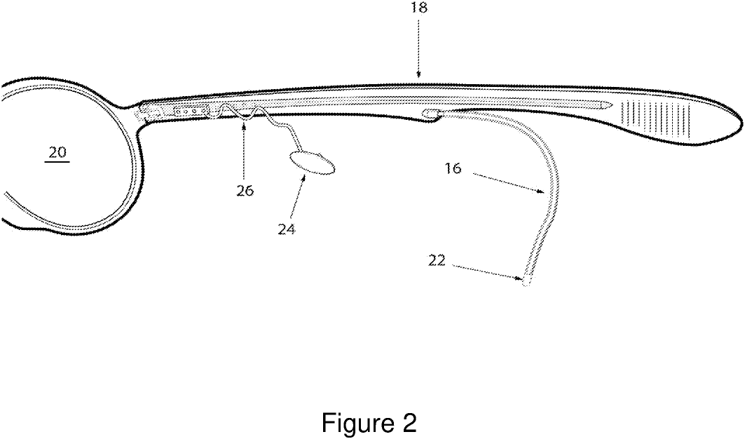

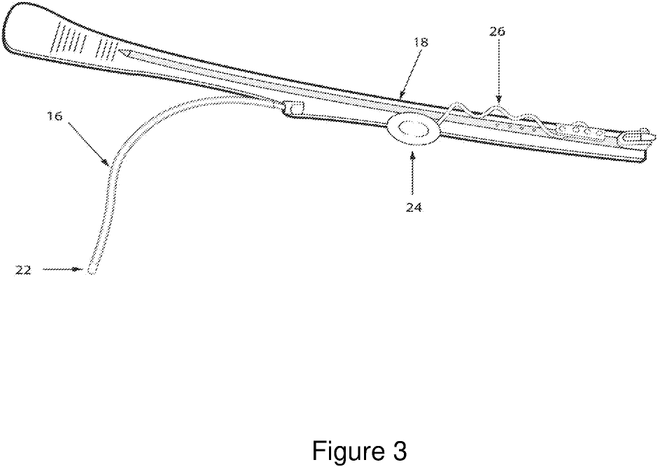

As shown in FIG. 2 and FIG. 3, the side supports 14 may have a cord portion 26 extending from the temple bars 18 and ending with the pad 24. Each side support 14 may extend towards from the temple bars 18 towards each other. Each side support 14 may be biased towards each other in a manner such that when worn, the pads 24 urges upon the zygomatic region (zygomatic arch) of the wearer.

As shown in FIG. 3, each temple cable 16 may be shaped as a hook for attachment to a wearer’s ear. The temple cable 16 may be formed from a resilient material such as stainless steel, preferably surgical grade type stainless steel. It is contemplated that biocompatible material may be used for at least a part or a portion of the temple cable 16.

In some embodiments, the temple bars 18 may be integrally formed or molded with the temple cables 16. In some embodiments, the temple bars 18, temple cables 16 and side supports 14 may be integrated. In such embodiments, the temple cables 16 may extend from a portion of the temple bars 18, and the side supports 14 may extend from another portion of the temple bars 18.

In another embodiment, the side supports 14 may be fastened to temple bars 18 via fasteners such as screws, bolts, hinges and/or nuts. Other fasteners such as adhesives and or ferromagnetic type fasteners may be contemplated.

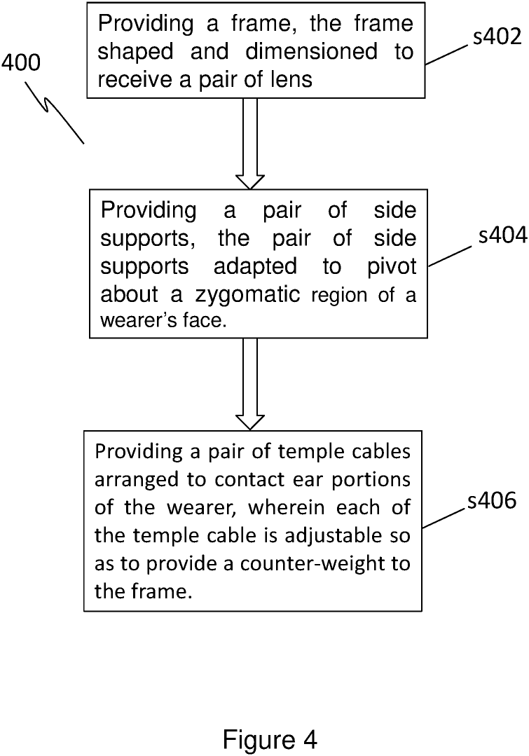

According with another aspect and with reference to FIG. 4 there is a method 400 for producing the eyewear 10 comprising the steps of: (a.) providing a frame 12, the frame 12 shaped and dimensioned to receive a pair of lens (step s402); (b.) providing a pair of side supports 14, the pair of side supports 14 adapted to pivot about a zygomatic region of a wearer’s face (step s404); and (c.) providing a pair of temple cables 16 arranged to contact ear portions of the wearer (step s406), wherein each of the temple cable is adjustable so as to provide a counter-weight or counter-force to the frame.

The eyewear 10 and/or frame 12 may include a pair of temple bars 18.

At least one dimension of the pair of side supports 14 may be adjusted so that the side supports 14 may be pivoted about the zygomatic region of the wearer’s face. The at least one dimension may be a length, a width and/or an angle of the pair of side supports 14. The angle may be with respect to the temple bars 18.

It is contemplated that the order of the method steps may be immaterial.

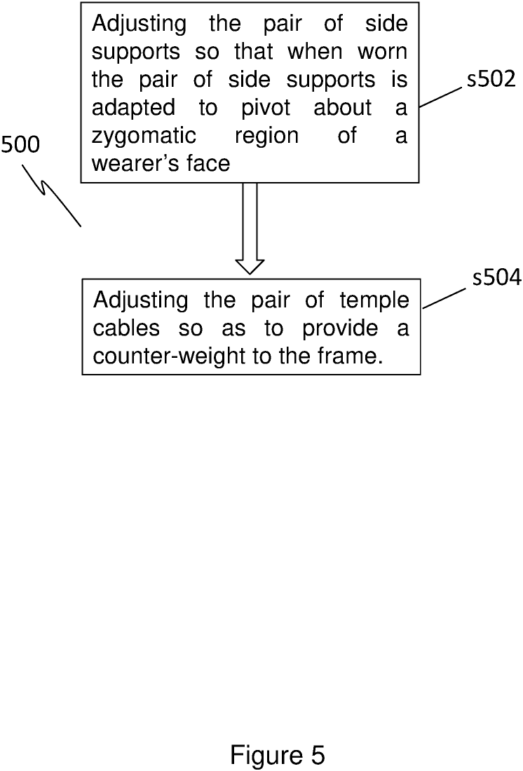

According with another aspect and with reference to FIG. 5 there is a method 500 for using the eyewear 10 having frame 12, a pair of side supports 14, a pair of temple cables 16 and a pair of temple bars 18. The method of use 500 may comprise the steps of: (a.) adjusting the pair of side supports 14 so that when worn the pair of side supports 14 is adapted to pivot about a zygomatic region of a wearer’s face (step s502); and (b.) adjusting the pair of temple cables 16 so as to provide a counter-weight to the frame 12 (step s504). From a lever perspective, the eyewear 10 may be regarded as a first-class lever.

At least one dimension of the pair of side supports 14 and the temple cables 16 may be adjusted. The said at least one dimension may be a length, a width and/or an angle of the pair of side supports 14 and/or the temple cables 16.

In some embodiments, the material used to form part or whole of the temple cables 16 and/or side supports 14 may be a surgical stainless steel 10/10.

In some embodiments, side support holders may be incorporated in the eyewear 10 to facilitate the attachment of the side supports 14 to the temple bars 18. The side support holders may be attached to the temple bars 18 and may be positioned along various positions along the temple bars 18. In one example, the side support holders include attachments/fasteners in the form of a nickel silver plate or nickel based alloys (e.g. Monel). A plurality of holes may be formed on the plate for fasteners to be attached thereon. For example, four (4) drilled holes each of 1.5 millimeters (mm) diameter may be formed to receive screws. The screws may be 1.4 mm screws.

In some embodiments, the side support holders may incorporate slidable mechanisms to facilitate the movement of the side support holders along the temple bars 18.

In some embodiments, the temple bars 18 and/or the temple cables 16 may be formed of or from an elastic/resilient material.

In some embodiments, the temple cables 16 may be detachable from the eyewear 10. Detachable temple cables 16 can facilitate the replacement and/or removal of the temple cables 16 with relative ease. The detachable temple cables 16 may be achieved by quick-release mechanisms and/or magnetic connectors.

In some embodiments, the side supports 14 and/or the side support holders may be detachable from the temple bars 18. This may be achieved by quick-release mechanisms and/or magnetic connectors.

In some embodiments, the cable temples 16 may be made of or formed from a resilient material of sufficient flexibility to enable a wearer to deform the same when anchored/hooked around the ear portion(s). When the deformation force is removed, it is appreciable that the cable temples 16 will return to its original shape.

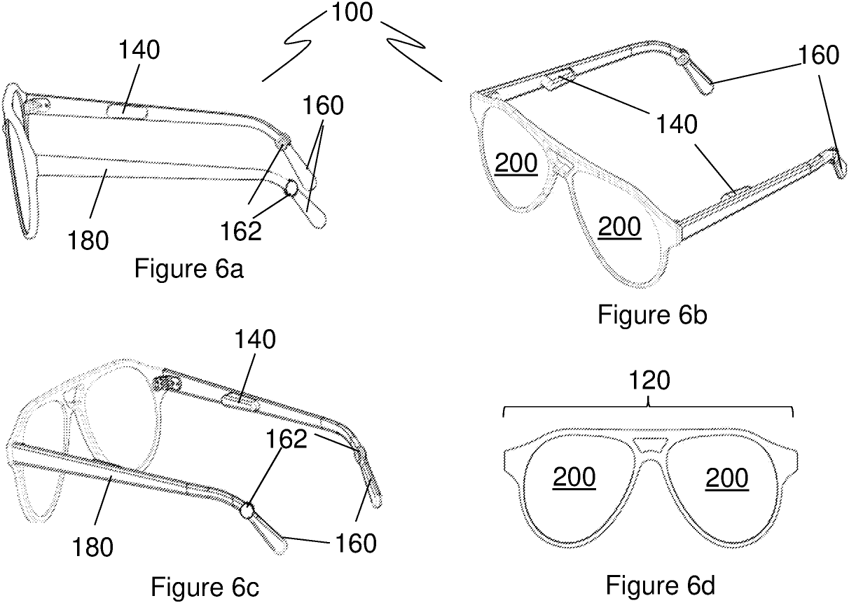

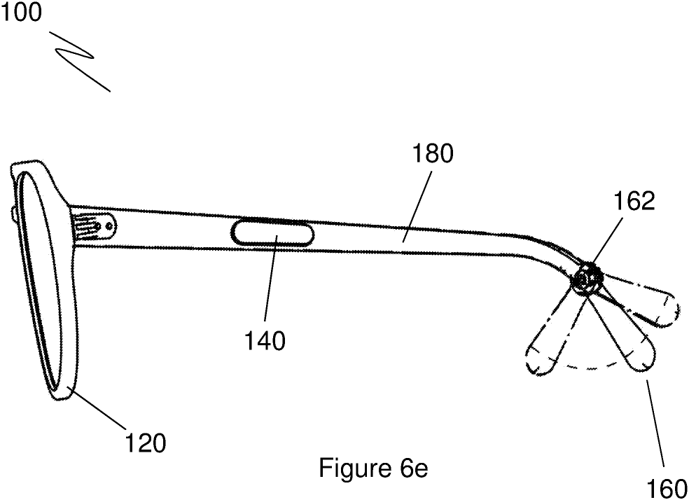

FIGS. 6a to 6e show perspective views of another embodiment of the eyewear 100. FIG. 6e illustrates temple contacts 160 of the eyewear 100 pivotable about a pair of temple bars 180.

The eyewear 100 may comprise a frame 120 for receiving lens 200, a pair of side supports 140 and a pair of temple contacts 160. The temple contacts 160 are pivotably mounted on a respective pair of temple bars 180. The embodiments of FIGS. 6a to 6e do not have nose supports, although it is contemplated that the eyewear 100 can include nose support(s).

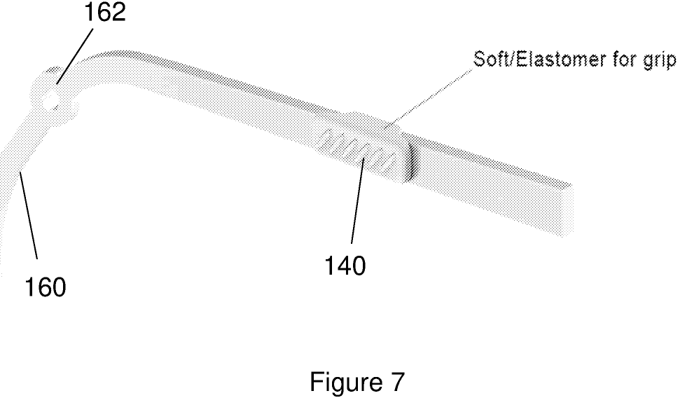

Each side support is in the form of an elongate pad 140. The elongate pad 140 may be attached to an inner surface of the temple bar 180. The elongate pad 140 may be formed from or of silicone material. Compared to the described embodiments, the eyewear 100 is advantageously less bulky and is less conspicuous/visible to a third party. Each silicone pad 140 is suitably shaped and dimensioned to maximize the contact with a zygomatic region, such as a zygomatic arch, of the wearer. It is appreciable that each side support 140 may be customized to the wearer’s head size and/or head profile. A side of the silicone pad 140 may include soft/elastomer material (See FIG. 7) to enhance friction and grip on the wearer’s face when worn. In some embodiments, the silicone pad 140 has a length of 18 millimeters and a width of 4 millimeters. In some embodiments, the silicone pad 140 may have a length in the range of 16 to 19 millimeters and a width of 3 to 5 millimeters.

In addition to the side supports 140, each pivotably mounted temple contact 160 may be shaped and dimensioned as an extension of the temple bar 180. The temple contact 160 may be regarded as an integration of functions of the end portion 22 and the temple cable 16 of the earlier described embodiment. The pivot mechanism joining the temple contact 160 to the respective temple bar 180 may be in the form of a hinge 162. The hinge 162 may be a torque or friction hinge operable to resist the pivoting motion so that the temple contact 160 stay in place when adjusted. The hinge 162 may comprise a durable center rivet. The pivotable temple contact 160 advantageously allows a user to easily adjust the contact required with the ear portion (e.g. back of the ear) so that the eyewear may be maintained above the nose to avoid or is arranged to minimize contact with the nose.

It is contemplated that an embodiment of the eyewear without nose support is suited for a variety of applications including the provision of an alternative eyewear for a user who has undergone a nose surgery. In addition, individuals or persons who have acne on their nose may wish to avoid placing eyewear on their nose as that can harbour bacteria causing further spread of acne or preventing proper treatment of acne.

It is further contemplated that an eyewear without nose support may be suitable for the following groups of individuals: individuals who would like to prevent nose dents / marks from occurring on their nose, individuals who like to prevent the weight of the eyeglass contributing to the dark circles around their eyes, and/or women wearing makeup want to avoid ruining their makeup.

It is contemplated that side supports 14 may have more than one cord portions 26 extending from the temple bar 18 and ending with corresponding pads 24. As an example, two cord portions 26 may extend from a temple bar 18 and ending with two corresponding pads 24.

In the described embodiments, the cable temple 16 and/or temple contact 160 may be formed from or of suitable materials that may deform when required but yet maintain certain level of ‘stiffness’ in a manner such as to allow customization to a wearer’s head profile and yet retains its position once adjusted so that the eyewear is elevated above the nose. Examples of such ‘flexible-yet-stiff’ materials include silicone or nitinol. Specific to temple contact 160, the friction or torque hinge 162 may further enhance the ability of the eyewear to be elevated above the nose. It is appreciable that the combination of the cable contact 160 and friction hinge 162 enables a user to adjust the tensile strength / counter force acting on the posterior portion of the ear and opposing the force of gravity so that the eyewear can be elevated above the nose of the wearer.

It should be further appreciated by the person skilled in the art that variations and combinations of features described above, not being alternatives or substitutes, may be combined to form yet further embodiments falling within the intended scope of the invention.

1. An eyewear comprising
a frame to receive a pair of lens;
a pair of temple bars extending from the frame;
a pair of side supports adapted to pivot about a zygomatic region of a wearer’s face; and
a pair of temple cables arranged to contact ear portions of the wearer;
wherein each of the temple cable is adjustable so as to provide a counter-weight to the frame.

2. The eyewear of claim 1, wherein the pair of temple cables is arranged as an extension from the pair of temple bars.

3. The eyewear of claim 1, further comprises a weight attached to an end portion of each of the temple cables.

4. The eyewear of claim 1, wherein each of the pair of side supports is shaped and dimensioned to contact a zygomatic arch of the wearer.

5. The eyewear of claim 4, wherein each side support comprises a pad formed from at least one of: silicone, plastic, rubber, ora combination thereof.

6. The eyewear of claim 4, wherein each of the side supports is arranged in an inclined manner and biased towards each other.

7. The eyewear of claim 2, wherein each temple bar comprises a hook portion configured to engage a portion of the wearer’s ear.

8. The eyewear of claim 1, wherein the pair of temple cables is formed from or of a flexible-yet-stiff material.

9. A method of producing the eyewear comprising the steps of:
(a) providing a frame, the frame shaped and dimensioned to receive a pair of lens;
(b) providing a pair of side supports, the pair of side supports adapted to pivot about a zygomatic region of a wearer’s face; and
(c) providing a pair of temple cables arranged to contact ear portions of the wearer, wherein each of the temple cable is adjustable so as to provide a counter-weight to the frame.

10. The method of claim 9, wherein the step of providing a pair of side supports include a step of pivoting about a zygomatic arch of the wearer.

11. The method of claim 9, wherein step (c) includes the step of providing a weight at an end portion of each of the temple cables.

12. A method for using the eyewear of claim 1 comprising the steps of: (a) adjusting the pair of side supports such that when worn the pair of side supports is adapted to pivot about a zygomatic region of a wearer’s face; and (b) adjusting the pair of temple cables so as to provide a counter-weight to the frame.

13. An eyewear comprising
a frame to receive a pair of lens;
a pair of temple bars extending from the frame;
a side support positioned on each temple bar, the side support adapted to contact a zygomatic region of a wearer’s face; and
a temple contact extending from each temple bar, the temple contact pivotably connected to the temple bar via a friction hinge.

14. An eyewear comprising
a frame to receive a pair of lens;
a pair of temple bars extending from the frame;
a pair of side supports adapted to contact a zygomatic region of a wearer’s face;
wherein each side support is an elongate silicone pad, the elongate silicone pad having a surface coated with an elastomeric material/elastomer.

15. The eyewear of claim 13, wherein each side support is an elongate silicone pad, the elongate silicone pad having a surface coated with an elastomeric material/elastomer.

16. The eyewear of claim 13, wherein the zygomatic region is a zygomatic arch of the wearer.

17. The eyewear of claim 14, wherein the zygomatic region is a zygomatic arch of the wearer.

18. The eyewear of claim 15, wherein the zygomatic region is a zygomatic arch of the wearer.
